(19) United States
(12) Patent Application Publication
(10) Pub. No.: US 2010/0177527 A1
(43) Pub. Date: Jul. 15, 2010

(54) LIGHT EMITTING MODULE, FABRICATION METHOD THEREFOR, AND LAMP UNIT

(75) Inventors: Yasuaki Tsutsumi, Shizuoka (JP); Masanobu Mizuno, Shizuoka (JP); Tetsuya Suzuki, Shizuoka (JP); Tomoyuki Nakagawa, Shizuoka (JP)

Correspondence Address: FULWIDER PATTON LLP, HOWARD HUGHES CENTER, 6060 CENTER DRIVE, TENTH FLOOR, LOS ANGELES, CA, 90045, US

(73) Assignee: KOITO MANUFACTURING CO., LTD., Tokyo (JP)

(21) Appl. No.: 12/684,052

(22) Filed: Jan. 7, 2010

(30) Foreign Application Priority Data
Jan. 9, 2009 (JP) 2009-003882

(51) Int. Cl. B60Q 1/00; F21V 9/00; H01J 9/24

(52) U.S. Cl. 362/538; 362/293; 445/23

(57) ABSTRACT

In a light emitting module board, an electrode receiving the supply of current for light emission is provided in the light emitting surface of a semiconductor light emitting device. A light wavelength conversion member is a plate-like member mounted on the light emitting surface, and emits light after converting the wavelength of the light emitted by the semiconductor light emitting device. A relay electrode is provided in the surface of the light wavelength conversion member. The relay electrode extends from a position in contact with the electrode to an exposed position in the external space in a state where the light wavelength conversion member is mounted on the light emitting surface. The relay electrode is provided so that the upper part of the relay electrode, which is the exposed position, extends to a position located opposite to the lower part of the relay electrode which is the contacted position.

### BACKGROUND OF THE INVENTION

1. Field of the Invention

The present invention relates to a light emitting module, a fabrication method therefor, and a lamp unit provided with the light emitting module.

2. Description of the Related Art

Recent years have seen continuing development of technologies concerning light emitting modules using light emitting elements, such as LEDs (Light Emitting Diodes), as the light source for emitting strong light.

An example of an application is lamp units irradiating the front area of a vehicle. And the purpose of the development has been to achieve longer lifetime and lower power consumption for such lamps. Those applications, however, have required the light emitting modules to have high luminance or luminosity. Thus proposed to enhance the extraction efficiency of white light, for instance, have been illumination apparatuses which comprise a light emitting element mainly emitting blue light, a yellow fluorescent material emitting mainly yellow light through excitation by blue light, and a blue-transmitting yellow-reflecting means which reflects light of wavelengths above the yellow light from the yellow fluorescent material while allowing the transmission therethrough of the blue light from the light emitting element (See Reference (1) in the following Related Art List). Also, proposed to raise the conversion efficiency, for instance, has been a structure having a ceramic layer which is disposed in the path of light released by a light emitting layer (See Reference (2), for instance).

### Related Art List

(1) Japanese Patent Application Publication No. 2007-59864.
(2) Japanese Patent Application Publication No. 2006-5367.

A light emitting element, such as an LED, has an electrode provided on a light emitting surface, and Au wire or the like is sometimes bonded on this electrode. As described in Reference (2) in the above Related Art List, the development of a light emitting module using a ceramic layer containing phosphors is also underway. Even in the structure of such a light emitting module using a plate-like phosphor, it is required that the electrode and the Au wire be electrically conducted properly therebetween. Also, the uses of LEDs have been rapidly expanding in recent years, and the light emitting modules are all the more required to have high luminance or luminosity. Accordingly, it is desirable that the deterioration of luminance or luminosity as a result of increased conduction between the wire and the electrode be minimized.

### SUMMARY OF THE INVENTION

The present invention has been made to resolve the foregoing problems, and a purpose thereof is to reduce the deterioration of luminance or luminosity of a light emitting module and achieve a maximum electric conduction of a conductive portion provided on a light emitting surface of a light emitting element even if a light wavelength conversion member is mounted on the light emitting surface of the light emitting element.

In order to resolve the above problems, a light emitting module according to one embodiment of the present invention comprises: a light emitting element having a light emitting surface on which a first conductive portion receiving the supply of current for light emission is disposed; and a light wavelength conversion member which is a plate-like member mounted on the light emitting surface and emits light after converting a wavelength of the light emitted by the light emitting element. The light wavelength conversion member is provided with a second conductive portion which extends from a position in contact with the first conductive portion to an exposed position in an external space in a state where the light wavelength conversion member is mounted on the light emitting surface.

Another embodiment of the present invention relates to a method of fabricating a light emitting module. This method comprises: providing a second conductive portion, which extends from a position in contact with a first conductive portion to an exposed position in an external space when the first conductive portion receiving the supply of current for light emission is provided on a light emitting surface of a light emitting element, on a light wavelength conversion member which converts the wavelength of light emitted by the light emitting element; and mounting the light wavelength conversion member on the light emitting surface thereof in such a manner as to be in contact with the position in contact with the first conductive portion.

Still another embodiment of the present invention relates to a lamp unit. This lamp unit comprises: a light emitting module including a light emitting element having a light emitting surface on which a first conductive portion receiving the supply of current for light emission is disposed, and a light wavelength conversion member which is a plate-like material mounted on the light emitting surface and emits light after converting a wavelength of the light emitted by the light emitting element; and an optical element configured to collect the light emitted by the light emitting module. The light wavelength conversion member is provided with a second conductive portion which extends from a position in contact with the first conductive portion to an exposed position in an external space in a state where the light wavelength conversion member is mounted on the light emitting surface.

Still another embodiment of the present invention relates also to a lamp unit. This lamp unit comprises: a light emitting module including a plurality of light emitting elements each having a light emitting surface on which a first conductive portion receiving the supply of current for light emission is disposed, and a light wavelength conversion member which is a plate-like member mounted on the light emitting surfaces and emits light after performing converting a wavelength of the light emitted by the plurality of light emitting elements; and an optical element configured to collect the light emitted by the light emitting module. The light wavelength conversion member is provided with a plurality of second conductive portions which extend from positions in contact with the first conductive portions to exposed positions open in an external space in a state where the light wavelength conversion member is mounted on the light emitting surfaces of the plurality of light emitting elements, and each of the plurality of second conducive portions is so provided as to demarcate at least a part of light distribution pattern formed in a frontward direction of a vehicle.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a cross-sectional view showing a structure of an automotive headlamp according to a first embodiment of the present invention;

FIG. 2 illustrates a structure of a light emitting module board according to a first embodiment;

FIG. 3A is a perspective view showing a structure of a light emitting module according to a first embodiment;

FIG. 3B is a cross-sectional view thereof taken along the plane “P” of FIG. 3A;

FIG. 4A is a perspective view showing a structure of a light emitting module according to a second embodiment of the present invention;

FIG. 4B is a cross-sectional view thereof taken along the plane “Q” of FIG. 4A;

FIG. 5A is a perspective view showing a structure of a light emitting module according to a third embodiment of the present invention;

FIG. 5B is a cross-sectional view thereof taken along the plane “R” of FIG. 5A;

FIG. 6 is a perspective view showing a structure of a light emitting module according to a fourth embodiment of the present invention;

FIG. 7 is a perspective view showing a structure of a light emitting module according to a fifth embodiment of the present invention;

FIG. 8 is a perspective view showing a structure of a light emitting module according to a sixth embodiment of the present invention;

FIG. 9 is a perspective view showing a structure of a light emitting module according to a seventh embodiment of the present invention;

FIG. 10 is a perspective view showing a structure of a light emitting module according to an eighth embodiment of the present invention;

FIG. 11 is a perspective view showing a structure of a light emitting module according to a ninth embodiment of the present invention;

FIG. 12 is a perspective view showing a structure of a light emitting module according to a tenth embodiment of the present invention;

FIG. 13 is a perspective view showing a structure of a light emitting module according to an eleventh embodiment of the present invention;

FIG. 14 is a perspective view showing a structure of a light emitting module according to a twelfth embodiment of the present invention; and

FIG. 15 is a perspective view showing a structure of a light emitting module according to a thirteenth embodiment of the present invention.

### DETAILED DESCRIPTION OF THE INVENTION

The invention will now be described by reference to the preferred embodiments. This does not intend to limit the scope of the present invention, but to exemplify the invention.

Hereinbelow, the embodiments will now be described in detail with reference to drawings.

### First Embodiment

FIG. 1 is a cross-sectional view of automotive headlamp according to a first embodiment of the present invention. An automotive headlamp 10 includes a lamp body 12, a front face cover 14, and a lamp unit 16. A description is herein below given in such a manner that the left side of FIG. 1 is treated as a front part of the lamp unit, whereas the right side of FIG. 1 is treated as a rear part of the lamp unit. Also, a right side as viewed toward the front part of the lamp unit is called a right side of the lamp unit, whereas a left side as viewed toward the front part thereof is called a left side of the lamp unit. FIG. 1 is a cross-sectional view of the automotive headlamp 10 cut along the vertical plane including the optical axis of the lamp unit 16, as viewed from the left side of the lamp unit. When the automotive headlamp 10 is mounted on a vehicle, the automotive headlamps 10, which are formed bilaterally symmetrical to each other, are disposed in a left-side front part of the vehicle and a right-side front part thereof, respectively. FIG. 1 illustrates either one of such left and right automotive headlamps 10.

The lamp body 12 is formed in a box-like shape having an opening. The front face cover 14 is formed, in a bowl-like shape, of resin or glass having translucency. A rim of the front face cover 14 is fit to the opening of the lamp body 12. In this manner, a lamp chamber is formed in a region covered by the lamp body 12 and the front face cover 14.

The lamp unit 16 is placed within the lamp chamber. The lamp unit 16 is fixed to the lamp body 12 with aiming screws 18. A lower aiming screw 18 is configured such that it rotates when a leveling actuator 20 is actuated. Thus, with the leveling actuator 20 actuated, the optical axis of the lamp unit 16 is movable vertically.

The lamp unit 16 includes a projection lens 30, a support member 32, a reflector 34, a bracket 36, a light emitting module board 38, and a heat radiation fin 42. The projection lens 30 is a plano-convex aspheric lens, having a convex front surface and a plane rear surface, which projects a light source image formed on a rear focal plane toward a front area of the lamp as a reverted image. The support member 32 supports the projection lens 30. A light emitting module 40 is disposed on the light emitting module board 38. The reflector 34 reflects light from the light emitting module 40 and forms the light source image on the rear focal plane of the projection lens 30. In this manner, the reflector 34 and the projection lens 30 function as optical elements that collect the light emitted by the light emitting module 40. The heat radiation fin 42, which is fit on a rear-side surface of the bracket 36, radiates the heat generated mainly by the light emitting module 40.

A shade 32a is formed in the support member 32. The automotive headlamp 10 is used as a low-beam light source. And the shade 32a shades part of light which is emitted from and light emitting module 40 and then reflected by the reflector 34, thereby forming cut-off line in a low-beam light distribution pattern in the frontward direction of the vehicle. Since the low-beam distribution pattern is known, the description thereof is omitted here.

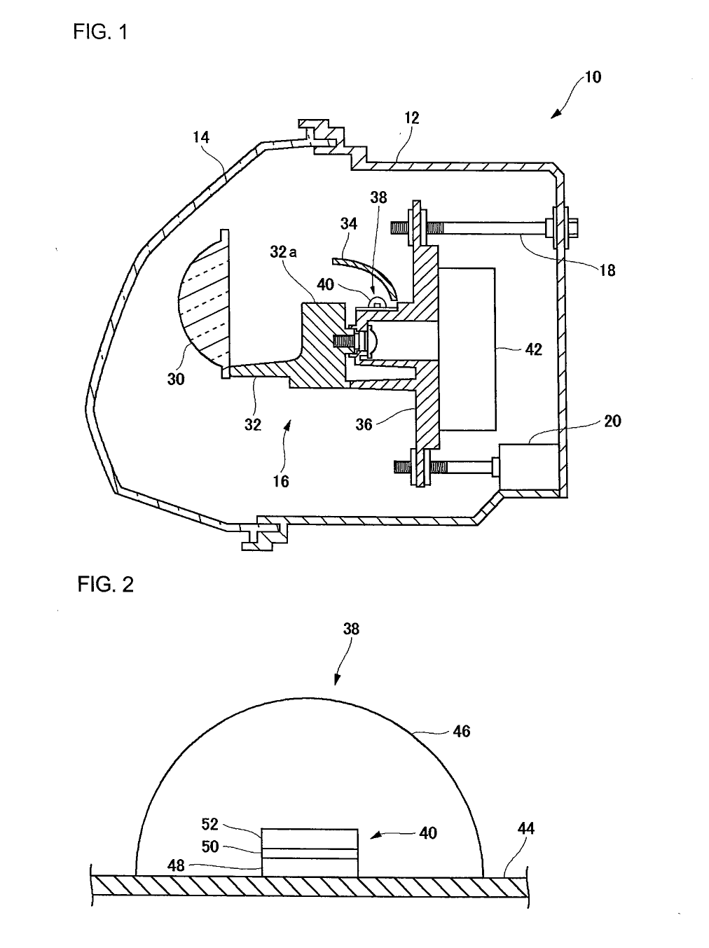

FIG. 2 illustrates a structure of a light emitting module board 38 according to the first embodiment. The light emitting module board 38 includes a light emitting module 40, a substrate 44, and a transparent cover 46. The substrate 44, which is a printed-circuit board, has the light emitting module 40 mounted on the top surface thereof. The light emitting module 40 is covered by the colorless transparent cover 46.

The light emitting module 40 is disposed in a stack of a semiconductor light emitting device 48, an intermediate member 50, and a light wavelength conversion member 52. More specifically, the semiconductor light emitting device 48 is mounted directly to the substrate 44, and the intermediate member 50 and the light wavelength conversion member 52 are stacked on top of the light emitting device 48 in this order.

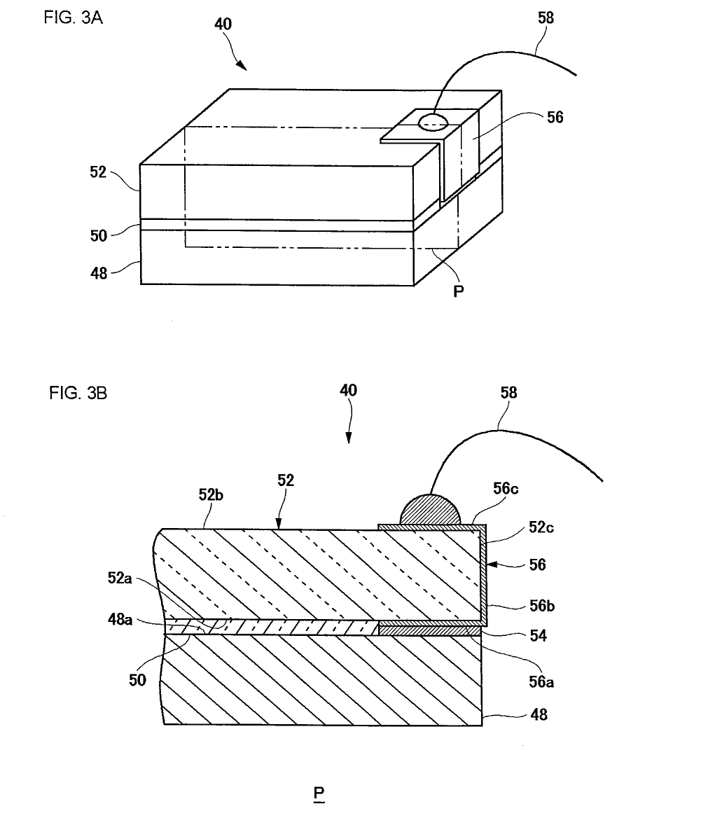

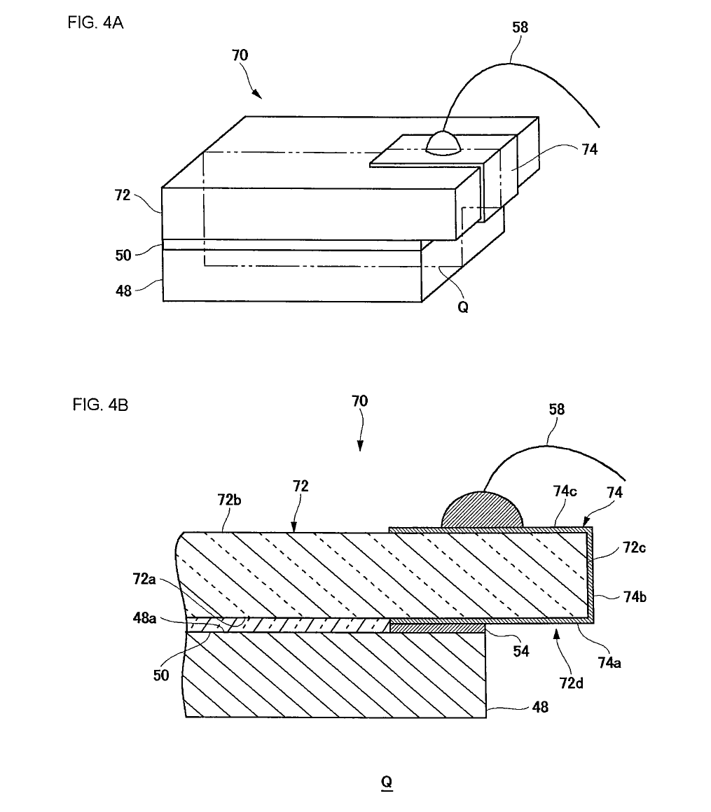

FIG. 3A is a perspective view showing a structure of a light emitting module 40 according to the first embodiment. FIG. 3B is a cross-sectional view thereof taken along the plane “P” of FIG. 3A. A semiconductor light emitting device 48 is comprised of an LED element. In the first embodiment, the semiconductor light emitting device 48 employed is a blue LED which emits light of mainly the wavelengths of blue light. More specifically, the semiconductor light emitting device 48 is constructed of an InGaN-based LED element which is formed through crystal growth of an InGaN-based semiconductor layer. The semiconductor light emitting device 48 is formed as a 1 mm square chip, for instance, and is disposed such that the center wavelength of the emitted blue light is 470 nm. It should be noted that the structure of the semiconductor light emitting device 48 and the wavelengths of light emitted thereby are not limited to those described above.

The semiconductor light emitting device 48 according to the first embodiment is a vertical chip type. The vertical chip type semiconductor light emitting device 48 has an n-type electrode formed on the face where it is mounted on the substrate, and stacked on top thereof are an n-type semiconductor, a p-type semiconductor, and a p-type electrode. Accordingly, an electrode 54, which is an electrically conductive body, or the p-type electrode, is provided on the top surface of the semiconductor light emitting device 48, i.e., a light emitting surface 48a thereof. Since the semiconductor light emitting device 48 such as described above is publicly known, further description thereof is omitted. It should be noted also that the semiconductor light emitting device 48 is not limited to the vertical chip type.

The electrode 54 receiving the supply of current for light emission is disposed such that one of the outer edges thereof are approximately aligned with the middle portion of an edge of the light emitting surface 48a of the semiconductor light emitting device 48. It goes without saying that the position of the electrode 54 is not limited to such a position as described above. For example, the electrode 54 may be so located at a corner of the light emitting surface 48 of the semiconductor light emitting device 38, or the electrode 54 may be so located as to be slightly closer to the center of the light emitting surface 48a from the edge of the light emitting surface 48a thereof such that the edge of the electrode 54 is not aligned with the edge of the light emitting surface 48a thereof.

The light wavelength conversion member 52 is a plate-like member in a rectangular form similar to that of the light emitting surface 48a of the semiconductor light emitting device 48. The light wavelength conversion member 52 is made of a so-called light emitting ceramic or fluorescent ceramic obtainable by sintering a ceramic green body prepared from yttrium aluminum garnet (YAG) powder, which is a fluorescent material that can be excited by blue light. Since the fabrication method of a light wavelength conversion ceramic such as described above is publicly known, detailed description thereof is omitted.

The light wavelength conversion member 52 thus obtained emits yellow light by converting the wavelength of blue light that is mainly emitted by the semiconductor light emitting device 48. Hence, light outputted from the light emitting module 40 is one synthesized from the blue light having been directly transmitted through the light wavelength conversion member 52 and the yellow light produced through wavelength conversion by the light wavelength conversion member 52. In this manner, white light can be emitted from the light emitting module 40.

The light wavelength conversion member 52 employed is a transparent one. The term “transparent” as used in the first embodiment is understood to mean a state where the transmission rate of all the light in the converted wavelength band is 40% or above. Through earnest and diligent R&D efforts of the inventors, it has been confirmed that the state of transparency where the transmission rate of all the light in the converted wavelength band is 40% or above makes it possible not only to properly convert the wavelengths of light by the light wavelength conversion member 52 but also to properly reduce the drop in the luminosity of light passing through the light wavelength conversion member 52. Accordingly, the light emitted by the semiconductor light emitting device 48 can be more efficiently converted by the selection of transparency of the light wavelength conversion member 52 as described above.

The light wavelength conversion member 52 is formed of a binderless inorganic substance, so that it displays improved durability compared with those containing organic matter such as a binder. Accordingly, it is possible to apply an electric power of 1 watt (W) or above, for instance, to the light emitting module 40, which helps raise the luminance and luminosity of the light emitted thereby.

It should be noted that the semiconductor light emitting device 48 to be employed may be one which mainly emits light of wavelengths other than those of blue. In such a case, too, the light wavelength conversion member 52 employed converts the wavelengths of the main light emitted by the semiconductor light emitting device 48. Even in this case, the light wavelength conversion member 52 may convert the wavelengths of the light emitted by the semiconductor light emitting device 48 in such a manner that white or a color having wavelengths close to those of white may be produced through combination with the wavelengths of light mainly emitted by the semiconductor light emitting device 48.

The intermediate member 50 is formed of a material with a refractive index lower than that of the light wavelength conversion member 52 so that the light emitted by the semiconductor light emitting device 48 can enter the light wavelength conversion member 52 smoothly. The intermediate member 50 is formed through solidification of a viscous or flexible material, such as an adhesive, after the intermediate member 50 is sandwiched between the light emitting surface 48a of the semiconductor light emitting device 48 and the incident surface of the light wavelength conversion member 52.

A relay electrode 56 is provided on a surface of the light wavelength conversion member 52. The relay electrode 56 is so formed as to extend from a portion thereof in contact with the electrode 54 to an portion exposed in an external space in a state where the light wavelength conversion member 52 is mounted on the light emitting surface 48a. Note that, in the present and the other embodiments to follow, the portion in contact with the electrode 54 will be herein below referred to simply as “contacted portion” or “contacted position” also. Also, the portion exposed in the external space will be herein below referred to simply as “exposed portion” or “exposed position” also. Accordingly, if the electrode 54 is expressed or recited as a first conductive portion, the relay electrode 56 will function as a second conductive portion which is in contact with the first conductive portion. The relay electrode 56 is formed such that a portion thereof extending from the contacted portion to the exposed portion is provided on the surface of the light wavelength conversion member 52.

More specifically, the relay electrode 56 is formed on the periphery of one edge 52c of the light wavelength conversion member 52 in such a manner that the relay electrode 56 extends continuously from an incident surface 52a of the light wavelength conversion member 52 onto an emission surface 52b along the edge 52c. Hereinbelow, of the relay electrode 56, a portion provided on the incident surface 52a is called a lower part 56a, a portion provided on the edge 52c is called a side part 56b, and a portion provided on the emission surface 52b is called an upper part 56c. In other words, the relay electrode 56 is comprised of three parts which are the lower part 56a, the side part 56b, and the upper part 56c. In the first embodiment, the lower part 56a of the relay electrode 56 is the portion in contact with the electrode 54, whereas the side part 56b and the upper part 56c thereof are the exposed portion in the external space.

In this manner, the relay electrode 56 is disposed so that the upper part 56c thereof, which is the exposed portion, extends to a position located counter to the lower part 56a, which is the contacted portion. In the first embodiment, the Au wire 58 is bonded to the upper part 56. And this arrangement makes the bonding of Au wire 56 easier. The current required for light emission is supplied to the electrode 54 through the Au wire 58.

In the fabrication of a light emitting module 40, a light wavelength conversion material larger in area than the light emitting surface 48a of the semiconductor light emitting device 48 is first cut into rectangles, approximately identical to that of the light emitting surface 48a of the semiconductor light emitting device 48, by dicing. Then the relay electrode 56 is provided in such a manner as to form the lower part 56a, the side part 56b and the upper part 56c. At this time, while regions other than those on which the relay electrode 56 is to be formed are masked by a masking material, a conductive material such as copper is sprayed, applied or vapor-deposited onto the light wavelength conversion member 52 and then the masking material is removed so as to produce the relay electrode 56. It is to be noted that the plate-like relay electrode 56 bent in a U-shape may be fit on the light wavelength conversion member 52.

Next, the light wavelength conversion member 52, with a pre-solidification intermediate member 50 applied on the incident surface, is mounted on the light emitting surface 48a of the semiconductor light emitting device 48. At this time, the light wavelength conversion member 52 is positioned so that the lower part 56a of the relay electrode 56 is in contact with the electrode 54. In this manner, the light wavelength conversion member 52 is fixed on the light emitting surface 48a of the semiconductor light emitting device 48 through the intermediate member 50.

Then the Au wire 58 is bonded to the upper part 56c of the relay electrode 56.

As described above, the light emitting module is configured such that the plate-like light wavelength conversion member 52 is mounted on the light emitting surface 48a of the semiconductor light emitting device 48. If, in this light emitting module, the electrode 54 is formed on the light emitting surface 48a and then the light wavelength conversion member 52 is mounted directly on the light emitting surface 48a, the electrode 54 will be covered by the light wavelength conversion member 52 and this makes it difficult to conduct electric current to the electrode 54. In contrast thereto, if, for example, a notch is formed in the light wavelength conversion member 52 such that the electrode 54 communicates with the external space, there is the possibility that the luminance may be unsteady and the light flux may deteriorate at the emission of light due to such a notch. Also, in order to provide such a notch, the light wavelength conversion member 52 may be subjected to a complex process, thus making it difficult to reduce the number of processes and cut down the processing cost. Also, since a certain level of accuracy is required in realizing a shape of the light wavelength conversion member 52, the yield of the light wavelength conversion members 52 may drop when such a process is performed.

Hence, provision of the relay electrode 56 on the surface of the light wavelength conversion member 52 eliminates the complex process required in the production of the light wavelength conversion member 52. As a result, the number of processes and the processing cost can be reduced. Furthermore, the light wavelength conversion member 52 is formed in a shape approximately identical to that of the light emitting surface 48a, so that the unsteady luminance and drop in light flux because of the provision of the notch in the light wavelength conversion member 52 cab be avoided.

### Second Embodiment

FIG. 4A is a perspective view showing a structure of a light emitting module according to a second embodiment of the present invention. FIG. 4B is a cross-sectional view thereof taken along the plane “Q” of FIG. 4A. Note that the structure of the automotive headlamp 10 is the same as that of the first embodiment except that a light emitting module 70 is used in the place of the light emitting module 40. Hereinbelow, the components identical to those of the first embodiment are given the identical reference numerals, and the repeated description thereof will be omitted.

The light emitting module 70 is configured such that a light wavelength conversion member 72 is mounted on the light emitting surface 48a of a semiconductor light emitting device 48 through an intermediate member 50. The material of the light wavelength conversion member 72 is the same as that of the aforementioned light wavelength conversion member 52. A relay electrode 74 is provided on a surface of the light wavelength conversion member 72. The relay electrode 74 is so formed as to extend from a portion thereof in contact with the electrode 54 to an exposed portion in an external space in a state where the light wavelength conversion member 72 is mounted on the light emitting surface 48a. Accordingly, if the electrode 54 is expressed or recited as a first conductive portion, the relay electrode 74 will function as a second conductive portion which is in contact with the first conductive portion.

The light wavelength conversion member 72 has a protruding portion 72d which is protruded from an end of the semiconductor light emitting device 48 when the light wavelength conversion member 72 is mounted on the light emitting surface 48a. The relay electrode 74 is formed on the periphery of an edge 72c of the protruding portion 72d in such a manner that the relay electrode 74 extends continuously from an incident surface 72a of the light wavelength conversion member 72 onto an emission surface 72b along the edge 72c. Hereinbelow, of the relay electrode 74, a portion provided on the incident surface 72a is called a lower part 74a, a portion provided on the edge 72c is called a side part 74b, and a portion provided on the emission surface 72b is called an upper part 74c. Of the relay electrode 74, a part of the lower part 74a is the portion in contact with the electrode 54, whereas the remaining part of the lower part 74a, the side part 74b and the upper part 74c are the exposed portion in the external space.

In the second embodiment, too, the relay electrode 74 is disposed so that the upper part 74c thereof, which is the exposed portion, extends to a position located counter to the lower part 74a, which is the contacted portion. In other words, the relay electrode 74 is formed such that the upper part 74c thereof extends to a position closer to the center of the semiconductor light emitting device 48 away from an edge thereof. More specifically, the relay electrode 74 is formed such that the end of the upper part 74c thereof extends to a position where the horizontal position thereof becomes approximately identical to the position of an end located closer to the center of the light emitting surface 48a of the electrode 54. This arrangement provides a wider area of the upper part 74c, so that the Au wire 58 can be bonded easily. The method of fabricating the light emitting module 70 is similar to the method of fabricating the light emitting module 40 according to the first embodiment except that the light wavelength conversion member 72 is so formed as to have the protruding portion 72d and also except that the relay electrode 74 is used in the place of the relay electrode 56.

### Third Embodiment

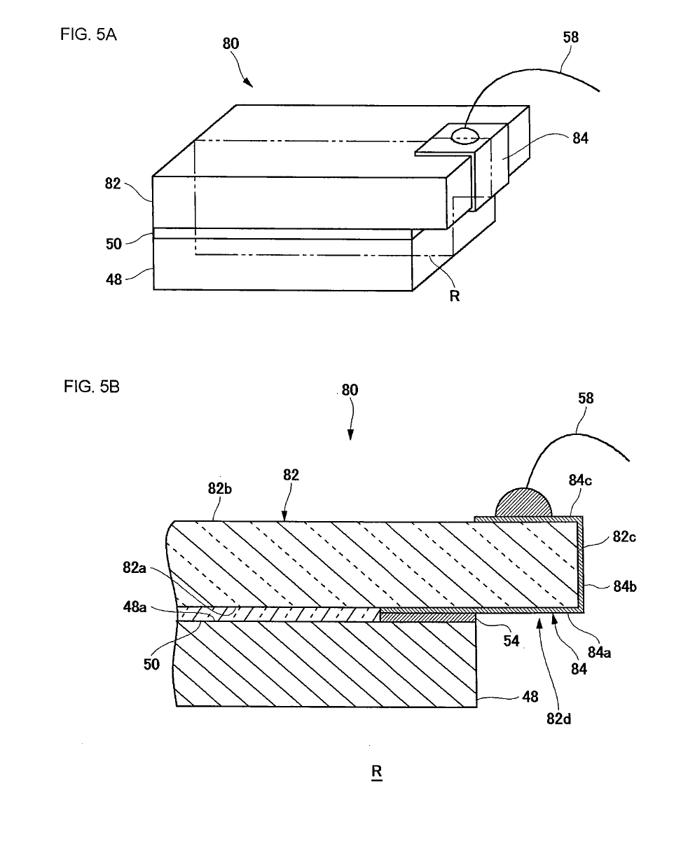

FIG. 5A is a perspective view showing a structure of a light emitting module according to a third embodiment of the present invention. FIG. 5B is a cross-sectional view thereof taken along the plane “R” of FIG. 5A. Note that the structure of the automotive headlamp 10 is the same as that of the first embodiment except that a light emitting module 80 is used in the place of the light emitting module 40. Hereinbelow, the components identical to those of the first embodiment are given the identical reference numerals, and the repeated description thereof will be omitted.

The light emitting module 80 is configured such that a light wavelength conversion member 82 is mounted on the light emitting surface 48a of a semiconductor light emitting device 48 through an intermediate member 50. The material of the light wavelength conversion member 82 is the same as that of the aforementioned light wavelength conversion member 52. A relay electrode 84 is provided on a surface of the light wavelength conversion member 82. The relay electrode 84 is so formed as to extend from a portion thereof in contact with the electrode 54 to an exposed portion in an external space in a state where the light wavelength conversion member 82 is mounted on the light emitting surface 48a. Accordingly, if the electrode 54 is expressed or recited as a first conductive portion, the relay electrode 84 will function as a second conductive portion which is in contact with the first conductive portion.

The light wavelength conversion member 82 has a protruding portion 82d which is protruded from an end of the semiconductor light emitting device 48 when the light wavelength conversion member 82 is mounted on the light emitting surface 48a. The relay electrode 84 is formed on the periphery of an edge 82c of the protruding portion 82d in such a manner that the relay electrode 84 extends continuously from an incident surface 82a of the light wavelength conversion member 82 onto an emission surface 82b along the edge 82c. Hereinbelow, of the relay electrode 84, a portion provided on the incident surface 82a is called a lower part 84a, a portion provided on the edge 82c is called a side part 84b, and a portion provided on the emission surface 82b is called an upper part 84c. Of the relay electrode 84, part of the lower part 84a is the portion in contact with the electrode 54, whereas the remaining part of the lower part 84a, the side part 84b and the upper part 84c are the exposed portion in the external space.

In the third embodiment, too, the relay electrode 84 is disposed so that the upper part 84c thereof, which is the exposed portion, extends to a position located counter to the lower part 84a, which is the contacted portion. The relay electrode 84 is formed such that the end of the upper part 84c thereof extends to a position where the horizontal position thereof becomes approximately identical to the position of an edge of the semiconductor light emitting device 48. Note that the end of the upper part 84c may extend only to a position where the horizontal direction thereof is farther from the edge of the semiconductor light emitting device 48.

The beams of light emitted from the light emitting surface 48a travel in various directions within the light wavelength conversion member 82. Thus, even if, for example, a region vertically above the electrode 54 is covered with an upper part of the relay electrode, the beam of light traveling obliquely from the light emitting surface 48a will be shielded by the relay electrode. Forming the relay electrode 84 in this manner can reduce the area of a part covered, by the relay electrode 84, of the region above the electrode 54. Accordingly, the drop in luminance or luminosity of the light emitting module 80 and the uneven luminance thereof can be suppressed. The method of fabricating the light emitting module 80 is similar to the method of fabricating the light emitting module 40 according to the first embodiment except that the light wavelength conversion member 82 is so formed as to have the protruding portion 82d and also except that the relay electrode 84 is used in the place of the relay electrode 56.

### Fourth Embodiment

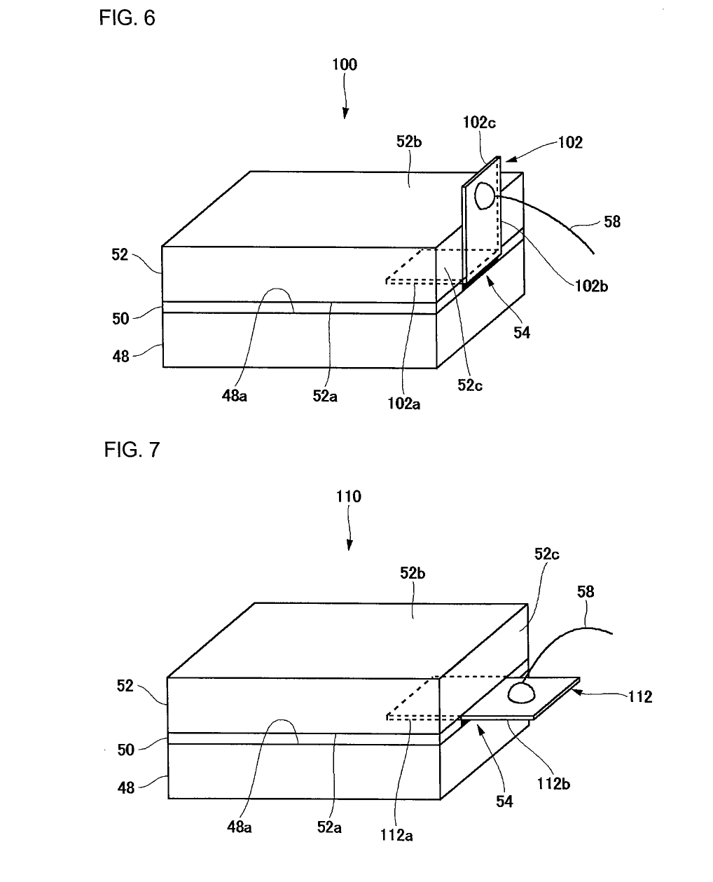

FIG. 6 is a perspective view showing a structure of a light emitting module according to a fourth embodiment of the present invention. Note that the structure of the automotive headlamp 10 is the same as that of the first embodiment except that a light emitting module 100 is used in the place of the light emitting module 40. Hereinbelow, the components identical to those of the first embodiment are given the identical reference numerals, and the repeated description thereof will be omitted.

The light emitting module 100 is configured such that a light wavelength conversion member 52 is mounted on the light emitting surface 48a of a semiconductor light emitting device 48 through an intermediate member 50. In the fourth embodiment, a relay electrode 102 is provided in the light wavelength conversion member 52. The relay electrode 102 is so formed as to extend from a portion thereof in contact with the electrode 54 to an exposed portion in an external space in a state where the light wavelength conversion member 52 is mounted on the light emitting surface 48a. Accordingly, if the electrode 54 is expressed or recited as a first conductive portion, the relay electrode 102 will function as a second conductive portion which is in contact with the first conductive portion.

The relay electrode 102 is prepared such that a conductive material such as copper is formed in a flat plate, cut into elongated rectangles and then bent into an L-shape. The relay electrode 102 is fixed such that one inner-surface part of the L-shape is firmly fixed to an incident surface 52a of the light wavelength conversion member 52 by adhesive bonding or the like whereas the other inner-surface part thereof is firmly fixed to an edge (side) 52c of the light wavelength conversion member 52 by adhesive bonding or the like, similarly. The relay electrode 102 is provided so that the part thereof firmly fixed to the edge 52 is longer than the height of the edge 52c. Accordingly, the relay electrode 102 is fixed to the light wavelength conversion member 52 in such a manner that the relay electrode 102 is protruded above an emission surface 52b. Further, a lower part 102a of the relay electrode 102 is disposed so that when the light wavelength conversion member 52 is placed over the semiconductor light emitting device 48, the lower part 102a thereof is placed in a position being in contact with the electrode 54 disposed on the light emitting surface 48a of the semiconductor light emitting device 48.

Hereinbelow, of the relay electrode 102, a portion mounted on the incident surface 52a of the light wavelength conversion member 52 is called the lower part 102a, a portion mounted on the edge 52c is called a side part 102b, and a portion protruding above the emission surface 52b is called a protrusion 102c. The lower part 102a is the portion in contact with the electrode 54, whereas the side part 102b and the protrusion 102c are the exposed portion in the external space.

An Au wire 58 is bonded to the protrusion 102c of the relay electrode 102. As described above, the electrode is not provided on the emission surface 52b of the light wavelength conversion member 52, so that optical loss can be reduced. Note that the Au wire 58 may be bonded to the side part 102b. The method of fabricating the light emitting module 100 is similar to the method of fabricating the light emitting module 40 according to the first embodiment except that the relay electrode 102 is provided beforehand in the light wavelength conversion member 52 in the place of the relay electrode 56.

### Fifth Embodiment

FIG. 7 is a perspective view showing a structure of a light emitting module according to a fifth embodiment of the present invention. Note that the structure of the automotive headlamp 10 is the same as that of the first embodiment except that a light emitting module 110 is used in the place of the light emitting module 40. Hereinbelow, the components identical to those of the first embodiment are given the identical reference numerals, and the repeated description thereof will be omitted.

The light emitting module 110 is configured such that a light wavelength conversion member 52 is mounted on the light emitting surface 48a of a semiconductor light emitting device 48 through an intermediate member 50. In the fifth embodiment, a relay electrode 112 is provided in the light wavelength conversion member 52. The relay electrode 112 is so formed as to extend from a portion thereof in contact with the electrode 54 to an exposed portion in an external space in a state where the light wavelength conversion member 52 is mounted on the light emitting surface 48a. Accordingly, if the electrode 54 is expressed or recited as a first conductive portion, the relay electrode 112 will function as a second conductive portion which is in contact with the first conductive portion.

The relay electrode 112 is prepared such that a conductive material such as copper is formed in a flat plate and then cut into elongated rectangles. The relay electrode 112 is fixed such that a part of the surface thereof is firmly fixed to an incident surface 52a of the light wavelength conversion member 52 by adhesive bonding or the like whereas the other part thereof is protruded horizontally from an edge 52c thereof.

Hereinbelow, of the relay electrode 112, a portion mounted on the incident surface 52a of the light wavelength conversion member 52 is called a coupled part 112a, and a portion protruding horizontally from the edge 52c is called a protrusion 112b. The coupled part 112a is the portion in contact with the electrode 54, whereas the protrusion 112b is the exposed portion in the external space. Thus, the coupled part 112 is placed in a position being in contact with the electrode 54 which is provided on the light emitting surface 48a when the light wavelength conversion member 52 is mounted over the semiconductor light emitting device 48.

An Au wire 58 is bonded to the protrusion 112b of the relay electrode 112. In the fifth embodiment, too, placing the electrode on the emission surface 52b of the light wavelength conversion member 52 can be avoided and therefore optical loss can be reduced. The method of fabricating the light emitting module 110 is similar to the method of fabricating the light emitting module 40 according to the first embodiment except that the relay electrode 112 is provided beforehand in the light wavelength conversion member 52 in the place of the relay electrode 56.

### Sixth Embodiment

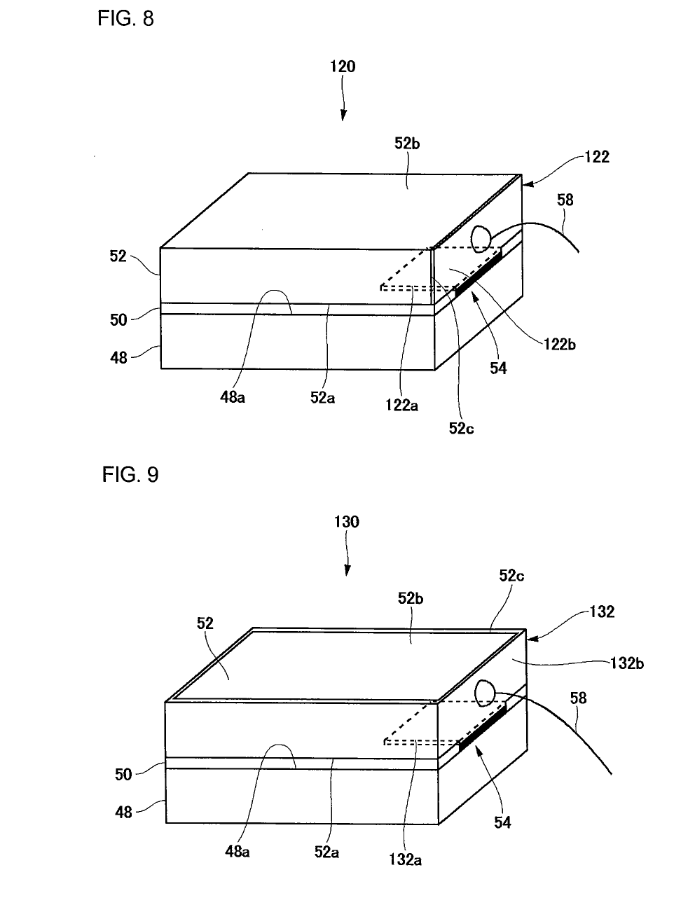

FIG. 8 is a perspective view showing a structure of a light emitting module according to a sixth embodiment of the present invention. Note that the structure of the automotive headlamp 10 is the same as that of the first embodiment except that a light emitting module 120 is used in the place of the light emitting module 40. Hereinbelow, the components identical to those of the first embodiment are given the identical reference numerals, and the repeated description thereof will be omitted.

The light emitting module 120 is configured such that a light wavelength conversion member 52 is mounted on the light emitting surface 48a of a semiconductor light emitting device 48 through an intermediate member 50. A relay electrode 122 is provided on the surface of the light wavelength conversion member 52. The relay electrode 122 is so formed as to extend from a portion thereof in contact with the electrode 54 to an exposed portion in an external space in a state where the light wavelength conversion member 52 is mounted on the light emitting surface 48a. Accordingly, if the electrode 54 is expressed or recited as a first conductive portion, the relay electrode 122 will function as a second conductive portion which is in contact with the first conductive portion.

More specifically, the relay electrode 122 is provided both on the incident surface 52a and one edge 52c of the light wavelength conversion member 52 wherein a portion of the relay electrode 122 on the incident surface 52a and a portion thereof on the edge 52c are connected to each other. Hereinbelow, of the relay electrode 122, the portion mounted on the incident surface 52a of the light wavelength conversion member 52 is called a lower part 122a, and the portion mounted on the edge 52c thereof is called a side part 122b. The lower part 122a is the portion in contact with the electrode 54, whereas the side part 122b is the exposed portion in the external space. The lower part 122a has size and shape similar to those of the electrode 54, whereas the side part 122b is provided over approximately entire region of the edge 52c. It should be noted that the size and the shape of the lower part 122a and the side part 122b are not limited to those described above.

While regions other than those on which the relay electrode 122 is to be formed are masked by a masking material, a conductive material such as copper is sprayed, applied or vapor-deposited onto the light wavelength conversion member 52 and then the masking material is removed so as to produce the relay electrode 122. It is to be noted that the plate-like relay electrode 122 bent in an L-shape may be fit on the light wavelength conversion member 52. Further, the lower part 122a is placed in a position being in contact with the electrode 54 provided on the light emitting surface 48a of the semiconductor light emitting device 48 when the light wavelength conversion member 52 is mounted above the semiconductor light emitting device 48.

An Au wire 58 is bonded to the side part 122b of the relay electrode 122. In the sixth embodiment, too, placing the electrode on the emission surface 52b of the light wavelength conversion member 52 can be avoided and therefore optical loss can be reduced. The method of fabricating the light emitting module 120 is similar to the method of fabricating the light emitting module 40 according to the first embodiment except that the relay electrode 122 is provided beforehand in the light wavelength conversion member 52 in the place of the relay electrode 56.

### Seventh Embodiment

FIG. 9 is a perspective view showing a structure of a light emitting module according to a seventh embodiment of the present invention. Note that the structure of the automotive headlamp 10 is the same as that of the first embodiment except that a light emitting module 130 is used in the place of the light emitting module 40. Hereinbelow, the components identical to those of the first embodiment are given the identical reference numerals, and the repeated description thereof will be omitted.

The light emitting module 130 is configured such that a light wavelength conversion member 52 is mounted on the light emitting surface 48a of a semiconductor light emitting device 48 through an intermediate member 50. A relay electrode 132 is provided on the surface of the light wavelength conversion member 52. The relay electrode 132 is so formed as to extend from a portion thereof in contact with the electrode 54 to an exposed portion in an external space in a state where the light wavelength conversion member 52 is mounted on the light emitting surface 48a. Accordingly, if the electrode 54 is expressed or recited as a first conductive portion, the relay electrode 132 will function as a second conductive portion which is in contact with the first conductive portion.

More specifically, the relay electrode 132 is provided on the incident surface 52a and all of the surfaces of four edges 52c of the light wavelength conversion member 52. Hereinbelow, of the relay electrode 132, the portion mounted on the incident surface 52a of the light wavelength conversion member 52 is called a lower part 132a, and the portions mounted on the edges 52c are called a side part 132b. The lower part 132a is the portion in contact with the electrode 54, whereas the side part 132b is the exposed portion in the external space. Thus, the lower part 132a is placed in a position being in contact with the electrode 54 provided on the light emitting surface 48a of the semiconductor light emitting device 48 when the light wavelength conversion member 52 is mounted above the semiconductor light emitting device 48. The lower part 132a has size and shape similar to those of the electrode 54, whereas the side part 132b is provided over approximately entire region of the edges 52c. It should be noted that the size and the shape of the lower part 132a and the side part 132b are not limited to those described above.

While regions other than those on which the relay electrode 132 is to be formed are masked by a masking material, a conductive material, such as silver, which may also be used as an optical mirror is sprayed, applied or vapor-deposited onto the light wavelength conversion member 52 and then the masking material is removed so as to produce the relay electrode 132. In the seventh embodiment described as above, the relay electrodes 132 are formed on all of the four edges 52 and therefore the relay electrodes 132 are used as the optical minor. As a result, the light leaked out of the edges 5c can be reduced and the conductivity of the electrode 54 can be increased.

An Au wire 58 is bonded to the side part 132b of the relay electrode 132. In the seventh embodiment, too, placing the electrode on the emission surface 52b of the light wavelength conversion member 52 can be avoided and therefore optical loss can be reduced. The method of fabricating the light emitting module 130 is similar to the method of fabricating the light emitting module 40 according to the first embodiment except that the relay electrode 132 is provided beforehand in the light wavelength conversion member 52 in the place of the relay electrode 56.

### Eighth Embodiment

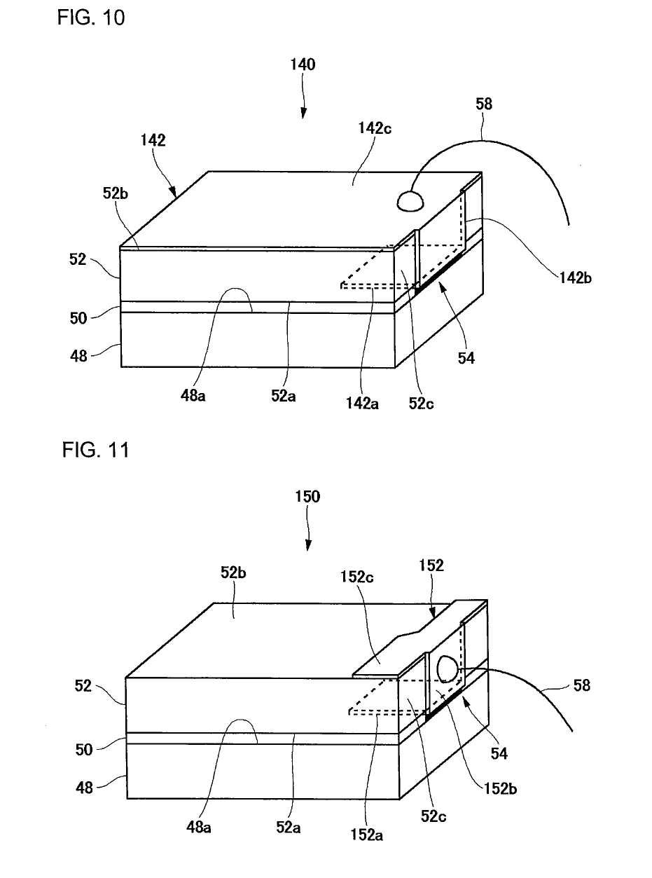

FIG. 10 is a perspective view showing a structure of a light emitting module according to an eighth embodiment of the present invention. Note that the structure of the automotive headlamp 10 is the same as that of the first embodiment except that a light emitting module 140 is used in the place of the light emitting module 40. Hereinbelow, the components identical to those of the first embodiment are given the identical reference numerals, and the repeated description thereof will be omitted.

The light emitting module 140 is configured such that a light wavelength conversion member 52 is mounted on the light emitting surface 48a of a semiconductor light emitting device 48 through an intermediate member 50. In the eighth embodiment, a relay electrode 142 is provided on the surface of the light wavelength conversion member 52. The relay electrode 142 is so formed as to extend from a portion thereof in contact with the electrode 54 to an exposed portion in an external space in a state where the light wavelength conversion member 52 is mounted on the light emitting surface 48a. Accordingly, if the electrode 54 is expressed or recited as a first conductive portion, the relay electrode 142 will function as a second conductive portion which is in contact with the first conductive portion.

More specifically, the relay electrode 142 is provided on the incident surface 52a, one edge 52c and the emission surface 52b of the light wavelength conversion member 52. Hereinbelow, of the relay electrode 142, a portion formed on the incident surface 52a of the light wavelength conversion member 52 is called a lower part 142a, a portion mounted on the edge 52c is called a side part 142b, and a portion formed on the emission surface 52b is called an upper part 142c. The lower part 142a is the portion in contact with the electrode 54, whereas the side part 142b is the exposed portion in the external space. Thus, the lower part 142a is placed in a position being in contact with the electrode 54 provided on the light emitting surface 48a of the semiconductor light emitting device 48 when the light wavelength conversion member 52 is mounted above the semiconductor light emitting device 48. The lower part 142a has size and shape similar to those of the electrode 54, whereas the upper part 142c is provided over approximately entire region of the emission surface 52b. It should be noted that the size and the shape of the lower part 142a and the upper part 142c are not limited to those described above.

The upper part 142c of the relay electrode 142 is formed of indium tin oxide (ITO) which is a conductive material. ITO is used as a so-called transparent electrode having optical transparency. Since the method of forming the ITO electrode is publicly known, the description thereof is omitted here.

An Au wire 58 is bonded to the upper part 142c of the relay electrode 142. Provision of the transparent ITO electrode on the emission surface 52b as described above suppresses a rise in optical loss caused by the relay electrode 142 and, at the same time, enlarges the region in which the Au wire 58 can be bonded. The method of fabricating the light emitting module 140 is similar to the method of fabricating the light emitting module 40 according to the first embodiment except that the relay electrode 142 is provided beforehand in the light wavelength conversion member 52 in the place of the relay electrode 56.

### Ninth Embodiment

FIG. 11 is a perspective view showing a structure of a light emitting module according to a ninth embodiment of the present invention. Note that the structure of the automotive headlamp 10 is the same as that of the first embodiment except that a light emitting module 150 is used in the place of the light emitting module 40. Hereinbelow, the components identical to those of the first embodiment are given the identical reference numerals, and the repeated description thereof will be omitted.

The light emitting module 150 is configured such that a light wavelength conversion member 52 is mounted on the light emitting surface 48a of a semiconductor light emitting device 48 through an intermediate member 50. A relay electrode 152 is provided on the surface of the light wavelength conversion member 52. The relay electrode 152 is so formed as to extend from a portion thereof in contact with the electrode 54 to an exposed portion in an external space in a state where the light wavelength conversion member 52 is mounted on the light emitting surface 48a. Accordingly, if the electrode 54 is expressed or recited as a first conductive portion, the relay electrode 152 will function as a second conductive portion which is in contact with the first conductive portion.

More specifically, the relay electrode 152 is provided on the incident surface 52a, one edge 52c and the emission surface 52b of the light wavelength conversion member 52 wherein a portion of the relay electrode 152 on the incident surface 52a and a portion thereof on the edge 52c are connected to each other and the portion thereof on the edge 52c and a portion thereof on the emission surface 52b are connected to each other. Hereinbelow, of the relay electrode 152, the portion mounted on the incident surface 52a of the light wavelength conversion member 52 is called a lower part 152a, the portion mounted on the edge 52c thereof is called a side part 152b, and the portion mounted on the emission surface 52b thereof is called an upper part 152c. The lower part 152a is the portion in contact with the electrode 54, whereas the side part 152b and the upper part 152c are the exposed portion in the external space. Thus, the lower part 152a is placed in a position being in contact with the electrode 54 provided on the light emitting surface 48a of the semiconductor light emitting device 48 when the light wavelength conversion member 52 is mounted above the semiconductor light emitting device 48. The lower part 152a has size and shape similar to those of the electrode 54, whereas the side part 152b is provided over approximately entire region of the edge 52c. It should be noted that the size and the shape of the lower part 152a and the side part 152b are not limited to those described above.

While regions other than those on which the relay electrode 152 is to be formed are masked by a masking material, a conductive material such as copper is sprayed, applied or vapor-deposited onto the light wavelength conversion member 52 and then the masking material is removed so as to produce the relay electrode 152. It is to be noted that the plate-like relay electrode 152 bent in a U-shape may be fit on the light wavelength conversion member 52.

An Au wire 58 is bonded to the side part 152b of the relay electrode 152. Note that the Au wire 58 may be bonded to the upper part 152c, instead. The method of fabricating the light emitting module 150 is similar to the method of fabricating the light emitting module 40 according to the first embodiment except that the relay electrode 152 is provided beforehand in the light wavelength conversion member 52 in the place of the relay electrode 56.

The upper part 152c of the relay electrode 152 is so provided as to demarcate a region near the horizontal line in a so-called low-beam light distribution pattern which is formed in the frontward direction of a vehicle. Thus, the automotive headlamp 10 on which the light emitting module 150 is mounted functions as a low-beam light source. Since the low-beam distribution pattern is known, the description thereof is omitted here. Note that the upper part 152c may be so provided as to demarcate at least a part of other light distribution patterns, such as a high-beam light distribution pattern, which are formed in the frontward direction of the vehicle. As described above, the relay electrode 152 is assigned to play a role of demarcating a light distribution pattern and therefore the cost can be cut down as compared with a case where a shade or the like is provided separately.

### Tenth Embodiment

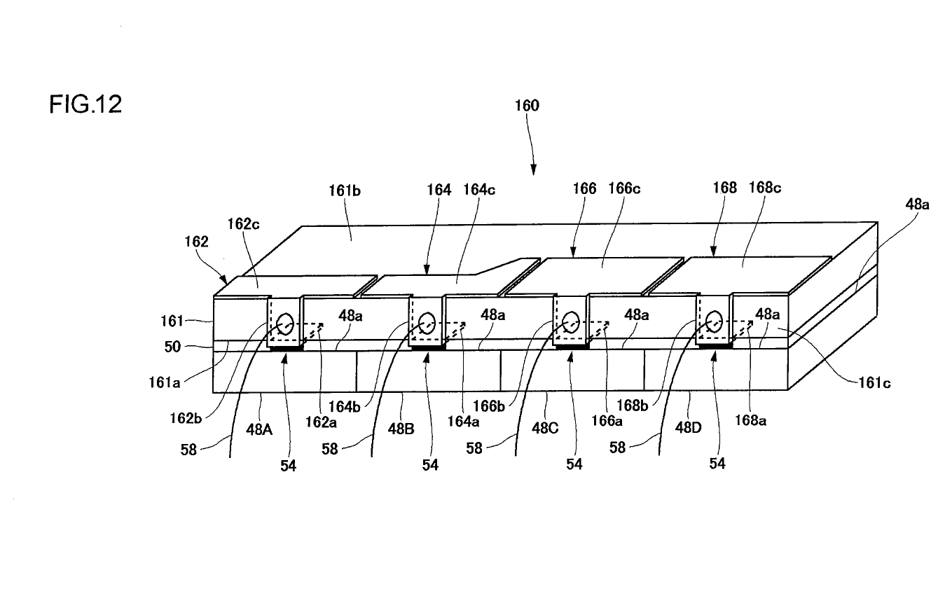

FIG. 12 is a perspective view showing a structure of a light emitting module according to a tenth embodiment of the present invention. Note that the structure of the automotive headlamp 10 is the same as that of the first embodiment except that a light emitting module 160 is used in the place of the light emitting module 40. Hereinbelow, the components identical to those of the first embodiment are given the identical reference numerals, and the repeated description thereof will be omitted.

The light emitting module 160 is configured such that an incident surface 161a of a light wavelength conversion member 161 is mounted on each light emitting surface 48a of a plurality of semiconductor light emitting devices 48 through an intermediate member 50. In the tenth embodiment, four semiconductor light emitting devices 48 are provided side-by-side on the same substrate and aligned with each other linearly such that the edges thereof are in contact with or adjacent to each other. As shown in FIG. 12, the four semiconductor light emitting devices 48 are herein below labeled as a first semiconductor light emitting device 48A to a fourth semiconductor light emitting device 48D, respectively, in this alignment sequence. The light wavelength conversion member 161 is a plate-like member mounted on the light emitting surfaces 48a of the four semiconductor light emitting devices 48, and thereby emits light after converting a wavelength of the light emitted by each of the four semiconductor light emitting devices 48. The material of the light wavelength conversion member 161 is the same as that of the aforementioned light wavelength conversion member 52. It should be noted that the number of semiconductor light emitting devices 48 is not limited to four and a plurality of semiconductor light emitting devices which are more than four light emitting devices may be provided.

In the tenth embodiment, a first relay electrode 162 to a fourth relay electrode 168 are provided on the surface of the light wavelength conversion member 161. The first relay electrode 162 to the fourth relay electrode 168 are each so formed as to extend from a portion thereof in contact with each electrode 54 to an exposed portion in an external space in a state where the light wavelength conversion member 161 is mounted on the light emitting surfaces 48a of the first semiconductor light emitting device 48A to the fourth semiconductor light emitting device 48D, respectively. Accordingly, if the electrodes 54 are expressed or recited as first conductive portions, the first relay electrode 162 to the fourth relay electrode 168 will function as second conductive portions which are in contact with the first conductive portions, respectively.

More specifically, the first relay electrode 162 is provided on the incident surface 161a, one edge 52c and the emission surface 161b of the light wavelength conversion member 161 wherein a portion of the relay electrode 152 on the incident surface 161a and a portion thereof on the edge 52c are connected to each other and the portion thereof on the edge 52c and a portion thereof on the emission surface 161b are connected to each other. Hereinbelow, of the relay electrode 162, the portion mounted on the incident surface 161a of the light wavelength conversion member 161 is called a lower part 162a, the portion mounted on the edge 52c thereof is called a side part 162b, and the portion mounted on the emission surface 161b thereof is called an upper part 162c. The lower part 162a is the portion in contact with the electrode 54, whereas the side part 162b and the upper part 162c are the exposed portion in the external space. Thus, the lower part 162a is placed in a position being in contact with the electrode 54 provided on the light emitting surface 48a of the semiconductor light emitting device 48 when the light wavelength conversion member 161 is mounted above the semiconductor light emitting device 48. The lower part 162a has size and shape similar to those of the electrode 54. It should be noted that the size and the shape of the lower part 162a are not limited to those described above.

The second relay electrode 164 is constituted by a lower part 164a, a side part 164b, and an upper part 164c. The third relay electrode 166 is constituted by a lower part 166a, a side part 166b, and an upper part 166c. The fourth relay electrode 168 is constituted by a lower part 168a, a side part 168b, and an upper part 168c. The lower part 164a, the lower part 166a and the lower part 168a are formed similarly to the lower part 162a of the first relay electrode 162. The side part 164b, the side part 166b and the side part 168b are formed similarly to the side part 162b of the first relay electrode 162. The upper part 164c, the upper part 166c and the upper part 168c have shapes different from the shape of the upper part 162a of the first relay electrode 162 but are formed such that they have the same length along the edge 161c and the like as the upper part 162a of the first relay electrode 162.

While regions other than those on which the first relay electrode 162 to the fourth relay electrode 168 are to be formed are masked by a masking material, a conductive material such as copper is sprayed, applied or vapor-deposited onto the light wavelength conversion member 161 and then the masking material is removed so as to produce the first relay electrode 162 to the fourth relay electrode 168. It is to be noted that the plate-like first relay electrode 162 to the plate-like fourth relay electrode 168 bent in a U-shape may be fit on the light wavelength conversion member 161. Au wires 58 are bonded to the side part 162b, the side part 164b, the side part 166b and the side part 168, respectively. Note also that the Au wires 58 may be bonded to the upper part 162c, the upper part 164c, the upper part 166c, or upper part 168c, instead. The method of fabricating the light emitting module 160 is similar to the method of fabricating the light emitting module 40 according to the first embodiment except that a plurality of semiconductor light emitting devices 48 are provided and the first relay electrode 162 is provided beforehand in the light wavelength conversion member 162 in the place of the relay electrode 56.

The upper part 162c, the upper part 164c, the upper part 166c and the upper part 168c are integrally configured and are so provided as to demarcate a region near the horizontal line in a so-called low-beam light distribution pattern which is formed in the frontward direction of a vehicle. Thus, the automotive headlamp 10 on which the light emitting module 160 is mounted functions as a low-beam light source. Note that the upper part 162c, the upper part 164c, the upper part 166c and the upper part 168c may be so provided as to demarcate at least a part of other light distribution patterns, such as a high-beam light distribution pattern, which are formed in the frontward direction of the vehicle.

### Eleventh Embodiment

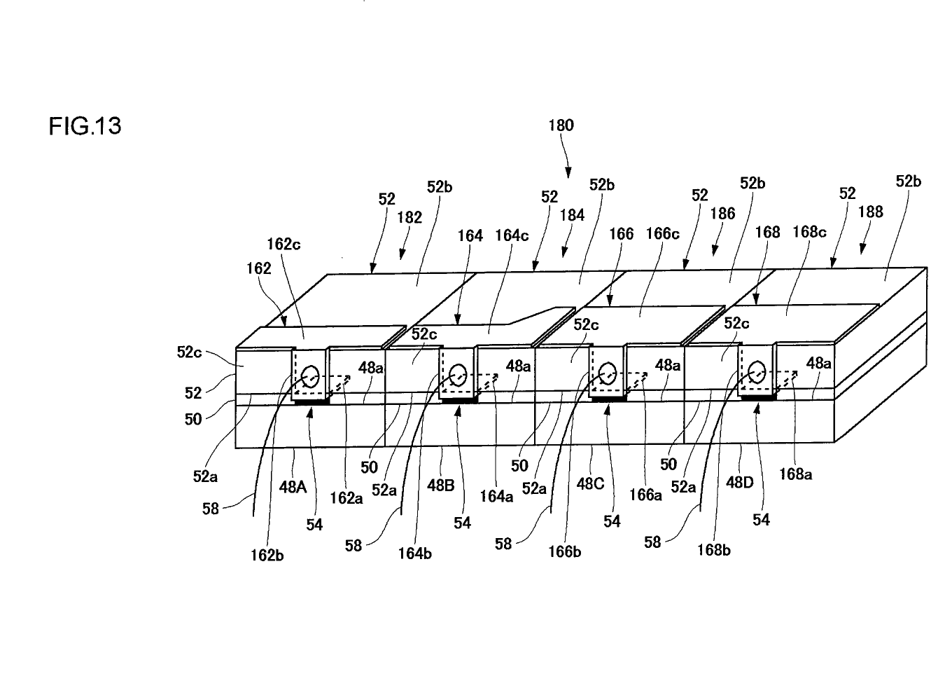

FIG. 13 is a perspective view showing a structure of a light emitting module according to an eleventh embodiment of the present invention. Note that the structure of the automotive headlamp 10 is the same as that of the first embodiment except that a light emitting module unit 180 is used in the place of the light emitting module 40. Hereinbelow, the components identical to those of the first embodiment are given the identical reference numerals, and the repeated description thereof will be omitted.

The light emitting module unit 180 includes a first light emitting module 182, a second light emitting module 184, a third light emitting module 186, and a fourth light emitting module 188. The first light emitting module 182 to the fourth light emitting module 188 are configured such that light wavelength conversion members 52 are mounted on the light emitting surfaces 48a of first semiconductor light emitting device 48A to fourth semiconductor light emitting device 48D, respectively. Each of a plurality of (or, four) light wavelength conversion members 52 are mounted on the light emitting surfaces 48a of a plurality of (or, four) semiconductor light emitting devices 48 respectively, and thereby emit light after converting a wavelength of the light emitted by each of the four semiconductor light emitting devices 48.

In the eleventh embodiment, a first relay electrode 162 to a fourth relay electrode 168 are provided on the respective surfaces of the four light wavelength conversion members 52. The first relay electrode 162 to the fourth relay electrode 168 are each so formed as to extend from a portion thereof in contact with each of the fourth electrodes 54 to an exposed portion in an external space in a state where the four light wavelength conversion members 52 are mounted on the respective light emitting surfaces 48a of the first semiconductor light emitting device 48A to the fourth semiconductor light emitting device 48D.

While regions other than those on which the first relay electrode 162 to the fourth relay electrode 168 are to be formed are masked by a masking material, a conductive material such as copper is sprayed, applied or vapor-deposited onto the light wavelength conversion members 52 and then the masking material is removed so as to produce the first relay electrode 162 to the fourth relay electrode 168. It is to be noted that the plate-like first relay electrode 162 to the plate-like fourth relay electrode 168 bent in a U-shape may be fit on the light wavelength conversion members 52. Au wires 58 are bonded to the side part 162b, the side part 164b, the side part 166b and the side part 168, respectively. Note also that the Au wires 58 may be bonded to the upper part 162c, the upper part 164c, the upper part 166c, or upper part 168c, instead. The method of fabricating the light emitting module unit 180 is similar to the method of fabricating the light emitting module 40 according to the first embodiment except that the first relay electrode 162 is provided beforehand in the light wavelength conversion member 52 in the place of the relay electrode 56.

The upper part 162c, the upper part 164c, the upper part 166c and the upper part 168c are integrally configured and are so provided as to demarcate a region near the horizontal line in a so-called low-beam light distribution pattern which is formed in the frontward direction of a vehicle. Thus, the automotive headlamp 10 on which the light emitting module unit 180 is mounted functions as a low-beam light source.

Note that the upper part 162c, the upper part 164c, the upper part 166c and the upper part 168c may be so provided as to demarcate at least a part of other light distribution patterns, such as a high-beam light distribution pattern and an additional light distribution pattern provided separately from the low-beam light distribution pattern, which are formed in the frontward direction of the vehicle.

### Twelfth Embodiment

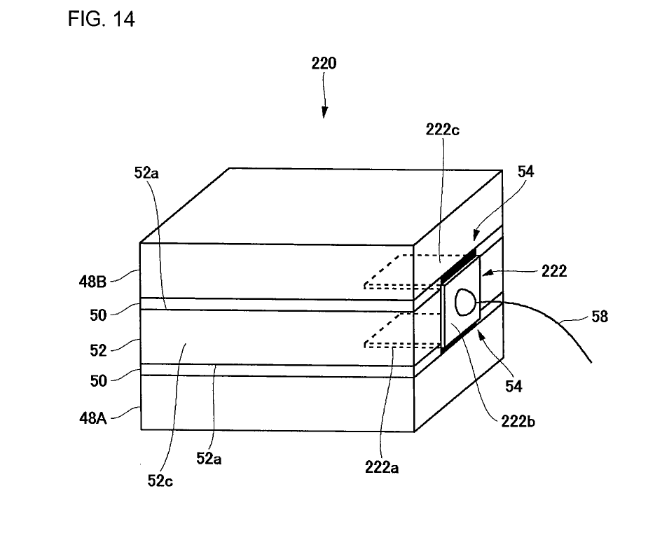

FIG. 14 is a perspective view showing a structure of a light emitting module according to a twelfth embodiment of the present invention. Note that the structure of the automotive headlamp 10 is the same as that of the first embodiment except that a light emitting module 220 is used in the place of the light emitting module 40. Hereinbelow, the components identical to those of the first embodiment are given the identical reference numerals, and the repeated description thereof will be omitted.

In the twelfth embodiment, the two surfaces which is located counter to each other function as the incident surfaces 52a, whereas the edge 52c functions as a emission surface. The light emitting module 220 is configured such that one incident surface 52a is placed on a light emitting surface 48a of a semiconductor light emitting device 48 through an intermediate member 50 and such that the other incident surface 52a is placed on a light emitting surface 48a of another semiconductor light emitting device 48 through an intermediate member 50. Hereinbelow, assume that there are two semiconductor light emitting devices 48. And one of the semiconductor light emitting devices 48 is called a first semiconductor light emitting device 48A, whereas the other semiconductor light emitting device 48 is called a second semiconductor light emitting device 48B. In the light emitting module 220, the second semiconductor light emitting device 48B is placed over the light wavelength conversion member 52, and the first semiconductor 48A is placed below the light wavelength conversion member 52.

A relay electrode 222 is provided on the surfaces of the light wavelength conversion member 52. The relay electrode 222 is so formed as to extend from portions thereof in contact with the respective electrodes 54 of the two semiconductor light emitting devices 48 to an exposed portion in an external space in a state where the light wavelength conversion member 52 is mounted on a light emitting surface 48a. Accordingly, if the electrode 54 is expressed or recited as a first conductive portion, the relay electrode 222 will function as a second conductive portion which is in contact with the first conductive portion.

More specifically, the relay electrode 222 is provided on one incident surface 52a, one edge 52c and the other incident surface 52a of the light wavelength conversion member 52 wherein a portion of the relay electrode 222 on the one incident surface 52a and a portion thereof on the edge 52c are connected to each other and the portion thereof on the edge 52c and a portion thereof on the other incident surface 52a are connected to each other. Hereinbelow, of the relay electrode 222, the portion mounted on the lower incident surface 52a of the light wavelength conversion member 52 is called a lower part 222a, the portion mounted on the edge 52c thereof is called a side part 222b, and the portion mounted on the upper incident surface 52a thereof is called an upper part 222c. The lower part 222a and the upper part 222c are the portions in contact with the respective electrodes 54 of the first semiconductor light emitting device 48A and the second semiconductor light emitting device 48B, whereas the side part 222b is the exposed portion in the external space.

Thus, the lower part 222a is placed in a position being in contact with the electrode 54 of the first semiconductor light emitting device 48A and the upper part 222c is placed in a position being in contact with the electrode 54 of the second semiconductor light emitting device 48B, when the first semiconductor light emitting device 48A and the second semiconductor light emitting device 48B are placed on the two incident surfaces 52a of the light wavelength conversion member 52, respectively. The lower part 222a and the upper part 222c each has size and shape similar to those of the electrode 54.

While regions other than those on which the relay electrode 222 is to be formed are masked by a masking material, a conductive material such as copper is sprayed, applied or vapor-deposited onto the light wavelength conversion member 52 and then the masking material is removed so as to produce the relay electrode 222. It is to be noted that the plate-like relay electrode 222 bent in a U-shape may be fit on the light wavelength conversion member 52.

An Au wire 58 is bonded to the side part 222b of the relay electrode 222. The method of fabricating the light emitting module 220 is similar to the method of fabricating the light emitting module 40 according to the first embodiment except that the first relay electrode 222 is provided beforehand in the light wavelength conversion member 52 in the place of the relay electrode 56 and also except that another semiconductor light emitting device 48 is placed over the light wavelength conversion member 52 through the intermediate member 50.

In the arrangement according to the twelfth embodiment as described above, the two semiconductor light emitting devices 48 are used, so that the light having higher luminance can emit from the edge 52c. Note that minors may be provided around the light emitting module 220 such that the respective lights emitted from the four edges 52c can be reflected in a predetermined common direction. Also, optical mirrors may be formed on the surfaces of the edges 52 except for partial regions thereof. In this arrangement, the regions where the optical minors are not provided may function as the emission surfaces, thereby making it possible to emit the light having higher luminance.

### Thirteenth Embodiment

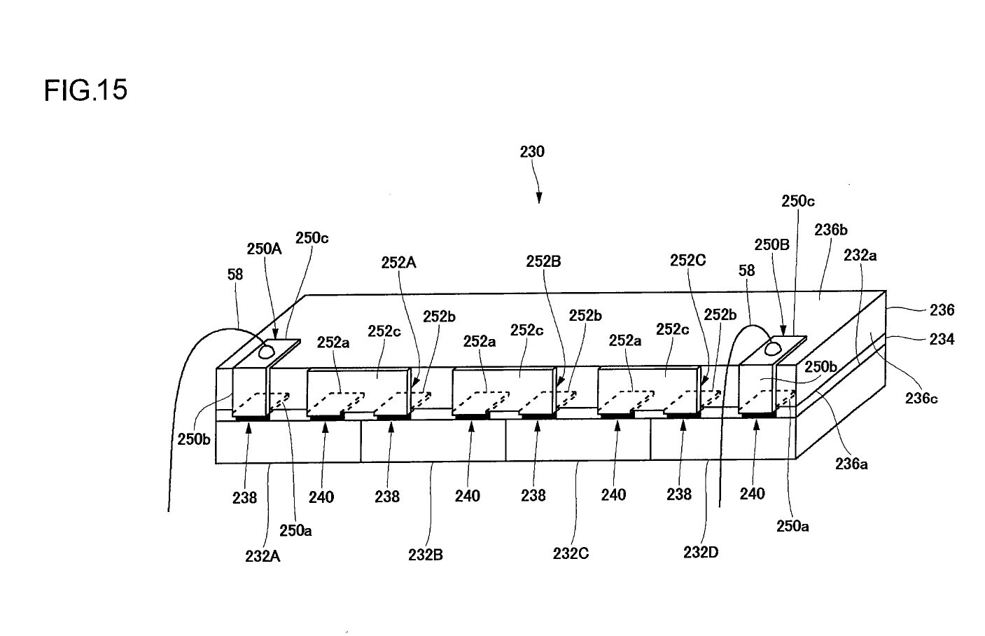

FIG. 15 is a perspective view showing a structure of a light emitting module according to a thirteenth embodiment of the present invention. Note that the structure of the automotive headlamp 10 is the same as that of the first embodiment except that a light emitting module 230 is used in the place of the light emitting module 40. Hereinbelow, the components identical to those of the first embodiment are given the identical reference numerals, and the repeated description thereof will be omitted.

The light emitting module 230 is configured such that a light wavelength conversion member 236 is mounted on each light emitting surface 232a of a plurality of semiconductor light emitting devices 232 through an intermediate member 234. The material of the intermediate member 234 is the same as that of the aforementioned intermediate member 50, and the material of the light wavelength conversion member 236 is the same as that of the aforementioned light wavelength conversion member 52. In the thirteenth embodiment, four semiconductor light emitting devices 232 are provided side-by-side on the same substrate and aligned with each other linearly such that the edges thereof are in contact with or adjacent to each other. As shown in FIG. 15, the four semiconductor light emitting devices 232 are herein below labeled as a first semiconductor light emitting device 232A to a fourth semiconductor light emitting device 232D, respectively, in this alignment sequence. The light wavelength conversion member 236 is a plate-like member mounted on the light emitting surfaces 232a of the plurality of semiconductor light emitting devices 232, and thereby emits light after converting a wavelength of the light emitted by each of the plurality of semiconductor light emitting devices 232. It should be noted that the number of semiconductor light emitting devices 232 is not limited to four and a plurality of semiconductor light emitting devices 232 which are more than four light emitting devices may be provided.

In the thirteenth embodiment, a so-called face-up type semiconductor light emitting device is used as the semiconductor light emitting device 232. In this face-up type semiconductor light emitting device, a sapphire substrate is provided on the face where it is mounted on the substrate 44, and stacked on top thereof is an n-type semiconductor. An n-type electrode is stacked on a part of the top surface of this n-type semiconductor, and a p-type semiconductor and a p-type electrode are formed on another part of the top surface of the n-type semiconductor. In this case, two electrodes, namely the p-type electrode and the n-type electrode, are provided on the emission surface of the semiconductor light emitting device. Hereinbelow, one of these two electrodes is called a first electrode 238 and the other thereof is called a second electrode 240. Since the semiconductor light emitting device such as this face-up type is also publicly known, further description thereof is omitted.

In the thirteenth embodiment, two termination relay electrodes 250 and three intermediate relay electrodes 252 are provided on the surface of the light wavelength conversion member 236. The three intermediate relay electrodes 252 are placed side by side along one edge 236c of the light wavelength conversion member 236, and the two termination relay electrodes 250 are disposed along said edge 236c in such a manner as to interpose the three intermediate relay electrodes 252 between the two terminal nation relay electrodes 250. The two termination relay electrodes 250 are herein below labeled as a first termination relay electrode 250A and a second termination relay electrode 250B, respectively. Also, the three intermediate relay electrodes 252 are herein below labeled as a first intermediate relay electrode 252A to a third intermediate relay electrode 252C, respectively. The first termination relay electrode 250A, the first intermediate relay electrode 252A, the second intermediate relay electrode 252B, the third intermediate relay electrode 252C, and the second termination relay electrode 250B are provided side by side, in this order, along the one edge 236 of the light wavelength conversion member 236.

Each termination relay electrode 250 is so formed as to extend from a portion thereof in contact with the first electrode 238 or second electrode 240 to an exposed portion in an external space in a state where the light wavelength conversion member 236 is mounted on the light emitting surfaces 232a. Accordingly, if the first electrode 238 and the second electrode 240 are expressed or recited as first conductive portions, the terminal relay electrodes 250 will function as second conductive portions which are in contact with the first conductive portions.

More specifically, each termination relay electrode 250 is provided on the incident surface 236a, one edge 236c and the emission surface 236b of the light wavelength conversion member 236 wherein a portion of the terminal relay electrode 250 on the incident surface 236a and a portion thereof on the edge 236c are connected to each other and the portion thereof on the edge 236c and a portion thereof on the emission surface 236b are connected to each other. Hereinbelow, of the termination relay electrode 250, the portion mounted on the incident surface 236a of the light wavelength conversion member 236 is called a lower part 250a, the portion mounted on the edge 236c thereof is called a side part 250b, and the portion mounted on the emission surface 236b thereof is called an upper part 250c. The lower part 250a is the portion in contact with the first electrode 238 or second electrode 240, whereas the side part 250b and the upper part 250c are the exposed portions in the external space.

Each intermediate relay electrode 252 is provided on the incident surface 236a in two positions and also provided on the one edge 236c in one position wherein two portions of the intermediate relay electrode 252 on the incident surface 236a and a portion thereof on the edge 236c are connected to each other. Hereinbelow, of the intermediate relay electrode 252, the portions mounted on the incident surface 236a of the light wavelength conversion member 236 are called a first lower part 252a and a second lower part 252b, and the portion mounted on the edge 236c thereof is called a side part 252c. The first lower part 252a and the second lower part 252b are the portion in contact with the first electrode 238 or second electrode 240, whereas the side part 252c is the exposed portion in the external space.

While regions other than those on which the termination relay electrodes 250 and the intermediate relay electrodes 252 are to be formed are masked by a masking material, a conductive material such as copper is sprayed, applied or vapor-deposited onto the light wavelength conversion member 236 and then the masking material is removed so as to produce the termination relay electrodes 250 and the intermediate relay electrodes 252. It is to be noted that the plate-like termination relay electrodes 250 bent in a U-shape may be fit on the light wavelength conversion member 236. Also, the plate-like intermediate relay electrodes 252 bent in a U-shape may be fit on the light wavelength conversion member 236.

The lower part 250a of the first termination relay electrode 250A is in contact with the first electrode 238 of the first semiconductor light emitting device 232A in the state where the light wavelength conversion member 236 is mounted on the light emitting surfaces 232a of the four semiconductor light emitting devices 232. The first lower part 252a of the first intermediate relay electrode 252A is in contact with the second electrode 240 of the first semiconductor light emitting device 232A, whereas the second lower part 252b thereof is in contact with the first electrode 238 of the second semiconductor light emitting device 232B. The first lower part 252a of the second intermediate relay electrode 252B is in contact with the second electrode 240 of the second semiconductor light emitting device 232B, whereas the second lower part 252b thereof is in contact with the first electrode 238 of the third semiconductor light emitting device 232C. The first lower part 252a of the third intermediate relay electrode 252C is in contact with the second electrode 240 of the third semiconductor light emitting device 232C, whereas the second lower part 252b thereof is in contact with the first electrode 238 of the fourth semiconductor light emitting device 232D. The lower part 250a of the second termination relay electrode 250B is in contact with the second electrode 240 of the fourth semiconductor light emitting device 232D. An Au wire 58 is bonded to the upper part 250c of the first termination relay electrode 250A. Also, an Au wire 58 is bonded to the upper part 250c of the second termination relay electrode 250B. Thus, if the current is applied between the Au wire 58 bonded to the first termination relay electrode 250A and the Au wire 58 bonded to the second termination relay electrode 250B, power can be supplied to all of the first semiconductor light emitting device 232A to the fourth semiconductor light emitting device 232D. In the light emitting module 230 configured as described above, the semiconductor light emitting devices 232 can be connected with each other without the use of wires, substrate wiring and the like. This achieves a simplified fabrication process of light emitting modules.

The present invention is not limited to each of the above-described embodiments only, and those resulting from any combination of the respective elements as appropriate are effective as embodiments. Also, it is understood by those skilled in the art that various modifications such as changes in design may be added to each of the embodiments based on their knowledge and the embodiments added with such modifications are also within the scope of the present invention.

In one modification, a so-called face-up type semiconductor light emitting device is used as the semiconductor light emitting device 48. If such a face-up type semiconductor light emitting device is used, a plurality of electrodes will be provided on the light emitting surface of the semiconductor light emitting device. Accordingly, on the surface of the light wavelength conversion member in each of the above-described embodiments a plurality of relay electrodes, which are in contact with a plurality of electrodes 54, respectively, are provided in a state where they are mounted on the light emitting surface of the semiconductor light emitting device or devices. Also, each of a plurality of relay electrodes is so formed as to extend from a portion thereof in contact with each electrode 54 to an exposed portion in an external space. Hence, even though a plurality of electrodes are provided on the light emitting surface of the semiconductor light emitting device, the deterioration of luminance or luminosity of a light emitting module can be reduced and the electric conduction of electrodes 54 provided on the light emitting surface of the semiconductor light emitting device can be maximized.

In another modification, an optical filter is provided between the light emitting surface of the semiconductor light emitting device in each of the above-described embodiments and the incident surface of the light wavelength conversion member therein. The optical filter transmits the blue light emitted mainly by the semiconductor light emitting device, and reflects the yellow light which is mainly emitted after the wavelength of blue light is converted by the light wavelength conversion member. The optical filter thus provided can realize an efficient use of light emitted from the semiconductor light emitting device and reduce the deterioration of luminosity or luminance of light emitted by the light emitting module.

In this case, a wavelength conversion unit is configured by first placing the optical filter substantially all over the light wavelength conversion member by bonding or the like. Then the relay electrode is formed on the surface of this wavelength conversion unit in a manner such that the relay electrode extends from a portion thereof in contact with the electrode 54 to an exposed portion in an external space in a state where the light wavelength conversion member is mounted on the light emitting surface 48a of the semiconductor light emitting device 48. At this time, while regions other than those on which the relay electrode is to be formed are masked by a masking material, a conductive material is sprayed toward or applied to the light wavelength conversion unit and then the masking material is removed so as to produce the relay electrode. It is to be noted that the plate-like relay electrode 56 bent in a U-shape may be fit on the light wavelength conversion unit. Hence, even though such an above-described optical filter is provided on the surface of the light wavelength conversion member, the deterioration of luminance or luminosity of a light emitting module can be reduced and the electric conduction of the electrode 54 provided on the light emitting surface 48a of the semiconductor light emitting device can be maximized.

In still another modification, the relay electrode is formed continuously on the incident surface and the edge of the light wavelength conversion member. Also, the relay electrode is not provided on the emission surface. The Au wire 58 is bonded to a part of the relay electrode which is formed on the edge. Thus, placing the electrode on the emission surface of the light wavelength conversion member can be avoided and therefore the deterioration of luminance or luminosity of light emitted by the light emitting module can be reduced.

In still another modification, a plate-like member such as copper sheet, aluminum wire, copper foil or aluminum ribbon wire, for instance, may be used instead of the Au wire 58. The plate-like member such as copper sheet is connected to the relay electrode by welding or soldering. According to this modification, the conductivity of the electrode 54 is enhanced even when the Au wire is not used.

In still another modification, the light emitting module unit 180 according to the eleventh embodiment forms an additional light distribution pattern. The additional light distribution patterns may be formed in strips extending in the horizontal direction that contains the horizontal line. The additional light distribution patterns are formed so that first to fourth partial light distribution patterns (not shown) arranged horizontally are integrated into one unit. The first light emitting module 182 to the fourth light emitting module 188 constitute the first partial light distribution pattern to the fourth partial light distribution pattern, respectively.

A not-shown vehicle where the automotive headlamps 10 are mounted is provided with not only a known high-beam switch (not shown) but also an intermediate-beam switch (not shown). As the intermediate-beam switch is turned on by a user, an intermediate mode starts. In the intermediate-beam mode, a glare experienced by a driver of a vehicle-in-front is reduced if a semiconductor light emitting device 48 which forms a partial light distribution pattern, among the first to fourth partial light distribution patterns, associated with a region where the vehicle-in-front exists is switched off.

More specifically, the vehicle where the automotive headlamps 10 are mounted is equipped with a camera (not shown) and a control unit (not shown). The control unit includes a CPU for executing various arithmetic processings, a ROM for storing various control programs, a RAM used as a work area for storing data and executing programs, and so forth. The control unit controls the illumination of the automotive headlamps 10. The camera has image pickup devices such as a CCD (Charge-Coupled device) sensor and a CMOS (Complementary Metal Oxide) sensor, and picks up images of an area in front of the vehicle so as to generate image data. The camera, which is connected to the control unit, outputs the thus generated image data to the control unit.

As the intermediate-beam switch is turned on by the user, an intermediate beam ON signal is outputted to the control unit and then the control unit starts to perform the irradiation light control of the automotive headlamp 10 in the intermediate-beam mode. While the intermediate-beam mode is on, the control unit analyzes the image data inputted from the camera and determines if there is a vehicle-in-front, such as an oncoming vehicle, whose headlamps, for instance, are lit. If there is such a vehicle-in-front, the position of the oncoming vehicle is identified using the position of the headlamps obtained through the analysis. Since a technique used to identify the position of a vehicle-in-front using the image data is publicly known, the repeated description thereof is omitted. Using the identified position of a vehicle-in-front, the control unit determines whether or not the vehicle-in-front exists in any of the first partial light distribution pattern to the fourth partial light distribution pattern. If the vehicle-in-front exists in any of the partial light distribution patterns, the control unit will switch off the semiconductor light emitting device 48 that forms said partial light distribution pattern. In this manner, the automotive headlamp 10 and the control unit function as an automotive headlamp system that controls the formation of light distribution patterns in an area in front of a vehicle.

It is to be noted that, instead of switching off the semiconductor light emitting device 48, the control unit may control the lighting of the semiconductor light emitting device 48 in such a manner that the luminosity of the irradiation light forming the partial light distribution pattern determined that there exists a vehicle-in-front is set lower than the luminosity thereof where no vehicle-in-front exists. Also, the upper part 162c, the upper part 164c, the upper part 166c and the upper part 168c may each be so provided as to demarcate a part of the additional light distribution pattern. Also, the upper part 162c, the upper part 164c, the upper part 166c and the upper part 168c may be removed from the emission surface 52b of the light wavelength conversion member 52.

What is claimed is:

1. A light emitting module comprising:
a light emitting element having a light emitting surface on which a first conductive portion receiving the supply of current for light emission is disposed; and
a light wavelength conversion member which is a plate-like member mounted on the light emitting surface and emits light after converting a wavelength of the light emitted by the light emitting element,
wherein the light wavelength conversion member is provided with a second conductive portion which extends from a portion thereof in contact with the first conductive portion to an exposed portion in an external space in a state where the light wavelength conversion member is mounted on the light emitting surface.

2. A light emitting module according to claim 1, wherein the second conductive portion is formed such that a portion thereof extending from the contacted portion to the exposed portion is provided on a surface of the light wavelength conversion member.

3. A light emitting module according to claim 2, wherein the second conductive portion is disposed so that the exposed portion extends to a position located counter to the contacted portion.

4. A light emitting module according to claim 3, wherein the light wavelength conversion member has a protruding portion which is protruded from an end of the light emitting element when the light wavelength conversion member is mounted on the light emitting surface, and
wherein the second conductive portion is so formed as to extend from the contacted portion to a surface of the protruding portion.

5. A light emitting module according to claim 1, wherein at least a part of the exposed portion, of the second conductive portion extending in the external space, which contains an end thereof is so placed as not to be in contact with the light wavelength conversion member.

6. A method of fabricating a light emitting module, the method comprising:
providing a second conductive portion, which extends from a position in contact with a first conductive portion to an exposed position in an external space when the first conductive portion receiving the supply of current for light emission is provided on a light emitting surface of a light emitting element, on a light wavelength conversion member which converts the wavelength of light emitted by the light emitting element; and
mounting the light wavelength conversion member on the light emitting surface thereof in such a manner as to be in contact with the position in contact with the first conductive portion.

7. A lamp unit comprising:
a light emitting module including a light emitting element having a light emitting surface on which a first conductive portion receiving the supply of current for light emission is disposed, and a light wavelength conversion member which is a plate-like member mounted on the light emitting surface and emits light after converting a wavelength of the light emitted by the light emitting element; and
an optical element configured to collect the light emitted by the light emitting module,
wherein the light wavelength conversion member is provided with a second conductive portion which extends from a position in contact with the first conductive portion to an exposed position in an external space in a state where the light wavelength conversion member is mounted on the light emitting surface.

8. A lamp unit according to claim 7, wherein the second conductive portion is so provided as to demarcate at least a part of light distribution pattern formed in a frontward direction of a vehicle.

9. A lamp unit comprising:
a light emitting module including a plurality of light emitting elements each having a light emitting surface on which a first conductive portion receiving the supply of current for light emission is disposed, and a light wavelength conversion member which is a plate-like member mounted on the light emitting surfaces and emits light after converting a wavelength of the light emitted by the plurality of light emitting elements; and
an optical element configured to collect the light emitted by the light emitting module,
wherein the light wavelength conversion member is provided with a plurality of second conductive portions which extend from positions in contact with the first conductive portions to exposed positions open in an external space in a state where the light wavelength conversion member is mounted on the light emitting surfaces of the plurality of light emitting elements, and
wherein each of the plurality of second conducive portions is so provided as to demarcate at least a part of light distribution pattern formed in frontward direction of a vehicle.
